(19) United States
(12) Patent Application Publication
(10) Pub. No.: US 2014/0312760 A1
(43) Pub. Date: Oct. 23, 2014

(54) LED LIGHT SOURCE

(71) Applicant: Anthony Augustine, Singapore (SG)

(72) Inventor: Anthony Augustine, Singapore (SG)

(73) Assignee: NOVALITE TECHNOLOGY PTE LTD, Singapore (SG)

(21) Appl. No.: 14/113,155

(22) PCT Filed: Jul. 12, 2011
(86) PCT No.: PCT/SG2011/000250

§ 371 Date: Nov. 19, 2013

(30) Foreign Application Priority Data
Apr. 26, 2011 (SG) 201102938

(51) Int. Cl. F21V 29/02; F21K 99/00

(52) U.S. Cl. CPC F21V 29/022; F21K 9/13; F21K 9/90
USPC 313/12; 29/825

(57) ABSTRACT

A light emitting diode (LED) light source, a method of manufacturing an LED light source, and a method of cooling an LED source. The LED light source comprises: an LED source; and an enclosure surrounding the LED source; wherein a gas or gas mixture is filled within the enclosure such that the gas or gas mixture acts as a medium for heat transfer away from the LED source; and wherein the gas or gas mixture is chosen to provide an increased heat transfer from the LED source compared to air.

### FIELD OF INVENTION

The invention relates to a light emitting diode (LED) light source, to method of manufacturing an LED light source, and to cooling an LED.

### BACKGROUND

Light emitting diode (LED) light sources provide light in many settings. LED light sources are relatively efficient, long-lasting, cost-effective, and environmentally friendly.

The performance of LED light sources largely depends on the ambient temperature of the operating environment. Overloading an LED light source in high ambient temperatures can result in overheating which may lead to device failure. Adequate heat dissipation is required to prolong the life span of LED light sources.

In particular, the LED has to maintain its diode junction temperature within the rated range to maximize efficiency, longevity, and reliability. Constant operation at high junction temperatures can result in less light output and a shorter life span. Most LEDs manufacturers claim their light output and other performance data on the basis of the junction temperature of 25° C. These performance data are derived from tests that are done within micro seconds after lighting up. Light output decreases as operation time increases and temperature increases.

An important design aspect of LED lighting is towards heat dissipation. Currently, the most common method of heat dissipation involves the use of heat sinks that are usually made of metals with good thermal conductivity characteristics. Heat is dissipated by means of surface contact between the LED array and the heat sink. However, cooling by heat sinks may not keep the junction temperature of LEDs close to the rated 25° C. for the claimed life span of 100,000 hours. This is because the rate of heat dissipation does not correspond with the rate of temperature rise of the LED (e.g. during a surge in supply voltage). When dust is collected and trapped in between the heat sinks' fins, the heat transfer rate deteriorates further, affecting the light output and lifespan of the LED.

LEDs can also be cooled by liquids. The liquids conduct heat away from the semiconductor junction to the surface of the LED enclosure by convection. Subsequently, the heat at the surface of the enclosure can be dissipated by radiation. However, the inherent viscosity and specific heat capacity of liquids cause delays in establishing a convection current that is able to dissipate heat effectively. Further, the heated liquids may release occluded gases, hindering effective convection.

A need therefore exists to provide a light emitting diode (LED) light source, and method of manufacturing and cooling the same that seeks to address at least one of the abovementioned problems.

### SUMMARY

According to the first aspect of the present invention, there is provided a light emitting diode (LED) light source, comprising: an LED source; and an enclosure surrounding the LED source; wherein a gas or gas mixture is filled within the enclosure such that the gas or gas mixture acts as a medium for heat transfer away from the LED source; and wherein the gas or gas mixture is chosen to provide an increased heat transfer from the LED source compared to air.

The heat may be transferred from the LED source to the surface of the enclosure by convection current.

The material of the enclosure may be chosen to facilitate the transmission of light and the transfer of heat from the surface of the enclosure to the ambient surroundings by radiation.

The surface of the enclosure may comprise glass.

The gas or gas mixture may have a combined molecular weight of less than 5.3.

The gas or gas mixture may have a combined thermal conductivity of more than 0.14 W/g/° C.

The enclosure may facilitate the funneling of the gas or gas mixture towards the LED source.

The LED source may comprise a LED semiconductor structure.

The LED light source may further comprise an electrical connection from the LED light source to the mains supply.

The LED light source may further comprise a stem for mounting the LED source within the enclosure.

The gas may comprise Hydrogen or Helium; and the gas mixture may comprise Nitrogen and Helium.

According to the second aspect of the present invention, there is provided a method of manufacturing a light emitting diode (LED) light source, comprising the steps of: mounting an LED source in an enclosure; exhausting ambient gas from the enclosure; and filling the enclosure with a gas or gas mixture such that the gas or gas mixture acts as a medium for heat transfer away from the LED source; and wherein the gas or gas mixture is chosen to provide an increased heat transfer from the LED source compared to air.

According to the third aspect of the present invention, there is provided a method of cooling a light emitting diode (LED), comprising the steps of: mounting the LED in an enclosure; and filling the enclosure with a gas or gas mixture such that the gas or gas mixture acts as a medium for heat transfer away from the LED; and wherein the gas or gas mixture is chosen to provide an increased heat transfer from the LED compared to air.

### BRIEF DESCRIPTION OF THE DRAWINGS

Example embodiments of the invention will be better understood and readily apparent to one of ordinary skill in the art from the following written description, by way of example only, and in conjunction with the drawings, in which:

FIG. 1a is a schematic diagram illustrating the structure of an LED light source, according to an embodiment of the present invention.

FIG. 1b is a schematic diagram illustrating the structure of an LED board of an LED light source, according to an embodiment of the present invention.

FIG. 1c is an electronic circuit diagram of an LED light source, according to an embodiment of the present invention.

FIG. 1d is an electronic circuit diagram of an LED light source, according to an embodiment of the present invention.

FIG. 2 is a schematic illustrating the formation of convection currents within an enclosure of an LED light source, according to an embodiment of the present invention.

FIG. 3 is a schematic illustrating the temperature distribution within an LED light source, according to an embodiment of the present invention.

FIG. 4a is a schematic diagram of an LED light source, according to an embodiment of the present invention.

FIG. 4b is a schematic diagram of an LED light source, according to another embodiment of the present invention.

FIG. 5 is a flow chart illustrating a method of manufacturing a light emitting diode (LED) light source, according to an example embodiment of the present invention.

FIG. 6 is a flow chart illustrating a method of cooling a light emitting diode (LED), according to an example embodiment of the present invention.

### DETAILED DESCRIPTION

Embodiments of the present invention seek to cool light emitting diode (LED) light sources so as to promote higher energy efficiency, longer life span and therefore provide cost benefits. Consequently, disadvantages associated with solid heat sinks and liquid cooling systems can be avoided.

In an example embodiment of the present invention, an LED source, here in the form of an LED semiconductor structure, is placed in an air-tight enclosure. The air-tight enclosure is filled with a pure gas or a mixture of gases. The gas or mixture of gases act as a medium to transfer heat from the LED source to the surface of the enclosure by gaseous convection. Heat from the surface of the enclosure is subsequently dissipated through radiation or convection with the ambient air.

Pure non-reactive (inert) gases or mixtures of non-reactive gases are preferred for cooling LEDs. The gas or gas mixture is preferably non-corrosive and does not react with the LED and the components within the enclosure. Further, the gas or gas mixture is preferably stable under heat and electric flow. Reactive and corrosive gases such as Oxygen, Halogens, Freons, Hydrocarbons and Refrigerants are not suitable for cooling LEDs.

Gases have relatively low molecular weights and are very mobile (compared to solids or liquids). For example, Hydrogen molecules move at a speed of 1840 m/s at 0° C. and 1930 m/s at 100° C. Gases with relatively heavier molecular weights are more sluggish compared with lighter ones. For example, the relatively heavier molecules of Air move at a slower speed of 484.3 m/s. Thus, Hydrogen molecules move about 4 times faster than Air molecules even without convection. Accordingly, gases with low molecular weights can carry away/transfer and dissipate heat relatively faster than solids and liquids and therefore gases are preferred in example embodiments. More preferably, the gas or gas mixture is chosen to have a molecular weight less than 5.3.

In an example embodiment, a gas mixture comprises 95% of He (molecular weight of 4.02) and 5% of N₂ (molecular weight of 28.03). Accordingly, the molecular weight of the gas mixture is [(0.95×4.02)+(0.05×28.03)]=5.221

In another example, the gas comprises 100% of H₂ (molecular weight of 2.01).

In yet another example embodiment, the gas comprises 100% of He (molecular weight of 4.02).

This is in contrast to conventional light bulbs, wherein the bulb is filled with a gas/gas mixture having a relatively larger molecular weight (e.g. argon) so as to minimize conduction and convection losses within the bulb and to reduce tungsten filament vaporization.

TABLE 1

| | | | Specific | Thermal | Cv = Specific |
|---|---|---|---|---|---|
| | | | gravity | conductivity | Heat at |
| | | Molecular | (g/l) at | (k) | Constant |
| Gas | Formula | weight | STP | (W/g/° C.) | Volume |
| Helium | He | 4.02 | 0.176 | 0.1513 | 0.7463 |
| Neon | Ne | 20.18 | 0.899 | 0.0491 | 0.1487 |
| Argon | Ar | 39.95 | 1.782 | 0.01772 | 0.0250 |
| Krypton | Kr | 83.80 | 3.75 | 0.00943 | 0.0119 |
| Xenon | Xe | 131.01 | 5.761 | 0.00565 | 0.0229 |
| Radon | Rn | 222.00 | 9.730 | 0.00361 | 0.0135 |
| Hydrogen | H₂ | 2.01 | 0.088 | 0.1805 | 2.4876 |
| Nitrogen | N₂ | 28.03 | 1.165 | 0.02583 | 0.1783 |
| Air | — | 28.97 | 1.293 | 0.02574 | |

N.B.: STP = Standard Temperature & Pressure, Standard Temperature = 300° K Standard Pressure = 14.7 psi = 760 mmHg

With reference to Table 1 above, the thermal conductivity (k) of Hydrogen is about 10 times more than Argon and about 7 times more than Nitrogen and Air. Accordingly, the use of gases with a relatively higher thermal conductivity is preferred in example embodiments. The gas or gas mixture is preferably chosen to have a thermal conductivity larger than that of air. More preferably, the gas or gas mixture is chosen to have a thermal conductivity larger than 0.14 W/g/° C.

In an example embodiment, a gas mixture comprising 95% of He and 5% of N₂ has a combined thermal conductivity of [(0.95×0.1513)+(0.05×0.02583)]=0.145 W/g/° C.

In another example, a gas comprising 100% of H₂ has a thermal conductivity of 0.1805 W/g/° C.

In yet another example, a gas comprising 100% of He has a thermal conductivity of 0.1513 W/g/° C.

In an example embodiment of the present invention, by using Hydrogen for cooling, it is possible to cool LEDs 7 times (4 times more mobile supporting conductivity and 7 times higher thermal conductivity) faster than cooling by Air with the heat sinks.

The type of gas or gas mixture used for cooling, their constituent ratios and proportions (for a gas mixture), and the pressure in which they are contained within the enclosure depend on the wattage, shape of the envelope and mass of the LED. In embodiments of the present invention, for a fixed enclosure size, as the wattage increases, the gas/gas mixture is chosen such that it has a higher thermal conductivity.

The amount of gas can be calculated from the following:

Sp. Gravity=gms/litre
Mass of gas inside the bulb volume of 0.12 litre at T=300° K at Atmospheric pressure of 14.7 psi=Sp. Gravity×0.12 gms.

### Example 1

95% He and 5% N₂

P: 14.7 psi

V: 0.12 litre

T: 300° K

Mass inside bulb=[(0.95×0.176)+(0.05×1.165)=0.2255]×0.12 gms=0.02706 gms

### Example 2

100% H₂

P: 14.7 psi

V: 0.12 litre

T: 300° K

Mass inside bulb=0.088×0.12 gms=0.01056 gms

### Example 3

100% He

P: 14.7 psi

V: 0.12 litre

T: 300° K

Mass inside bulb=0.176×0.12 gms=0.02112 gms

As the LED is operated, due to heat generated, the temperature rises from T1 (ambient temperature) to T2.

The heat generated, in calories per second, can be calculated using the formula:

H=m·s·t (3)

where
m=mass of the LED semiconductor.
s=specific heat of the LED semiconductor.
t=(T2−T1), the increase in temperature (in Kelvin)

The heat generated, in Joules per second (Watts), can be calculated using the formula:

$$\begin{matrix}{H}^{′} = 4.2 ( m \cdot s \cdot t ) watts & ( 4 ) \\ \begin{matrix}For cooling gas = 4.2 {m}^{′} \cdot Cv \cdot t watts \\ = 4.2 \times 0.01056 \times 5 / 2.01 \times 100 \\ = 11.03 watts is the cooling capacity \\ of hydrogen gas inside a 60 mm \\ glass bulb .\end{matrix} & \end{matrix}$$

The heat generated must be dissipated by the gas or gas mixture filled within the enclosure. Due to the nature of the chosen gas or gas mixture, cooling is rapid by convection current. The flow of the convection current within the enclosure is guided by the physical shape of the enclosure.

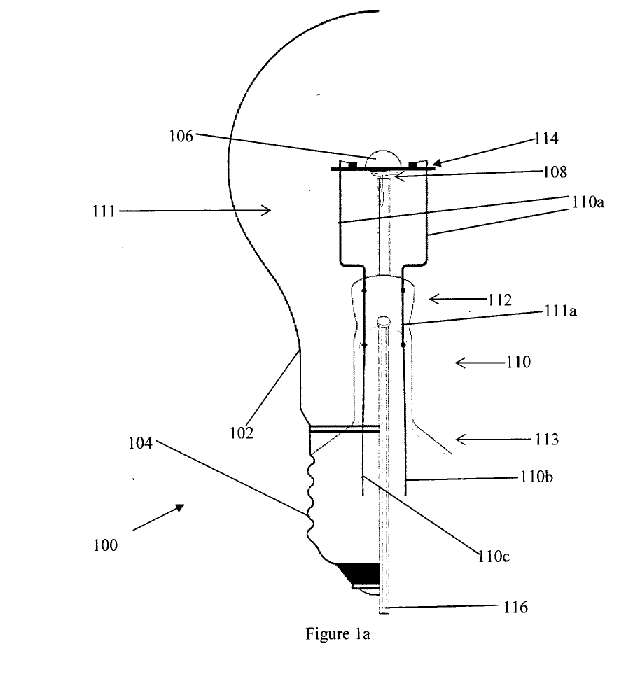

FIG. 1a is a schematic diagram, generally designated as reference numeral 100, illustrating the structure of an LED light source, according to an embodiment of the present invention. The LED light source 100 comprises an enclosure 102, a base 104, an LED semiconductor 106 mounted on an LED board 114 and a stem/mount assembly 110. The stem/mount assembly 110 comprises three portions: an upper portion 111, a middle portion 112 and a lower portion 113.

The upper portion 111 comprises an inner lead 110a (made of e.g. nickel plated steel (NPS) and a spring support 108. The middle portion 112 is made of glass and comprises a dumet wire 111a sealed within the middle portion 112. The dumet wire 111a preferably has a matching linear coefficient of expansion to the middle portion 112. The lower portion 113 comprises an outer lead; the outer lead comprising a copper portion 110b and a monel (fuse) portion 110c. The inner lead 110a, the dumet wire 111a and the outer lead 111b/c together form the lead-in-wire of the LED light source 100. The base 104 shown here is an Edison screw base, comprising a E27/27 cap. However, it will be appreciated by a person skilled in the art that other suitable bases, e.g. bayonet base, bipin can be used. FIG. 1 shows a single LED semiconductor 106. However, more than one LED semiconductor (i.e.: an array of LED semiconductors) can be used.

The LED board 114 can be rated at, e.g. 230V and 50 Hz and is available, by way of a non-limiting example, from Seoul Semi under the trade name Acriche with models such as A7 (rated at 6500K and 4500K), AW3231 and AN3231. They are also available e.g. from Samsung with model 603 (rated at 5000K).

The LED light source 100 further comprises an exhaust tube 116. The LED board 114 is mounted above the upper portion 111 of the stem/mount assembly 110. The stem/mount assembly 110 is sealed inside the enclosure 102. The air inside the enclosure 102 is exhausted via the exhaust tube 116 using e.g. a vacuum pump, heated and degassed. Thereafter, the enclosure 102 is filled with gases/gas mixtures such as those mentioned above (i.e. Examples 1-4) and the exhaust tube is sealed/closed by melting.

FIG. 1b is a schematic diagram illustrating the top view of the LED board 114, according to an embodiment of the present invention. The LED semiconductor 106 is mounted on the board 114. The board 114 comprises electrical control circuitry 120 and openings 122 for inner leads 110a to pass through the board 114. The inner leads 110a may be electrically connected to the circuitry 120 (and the LED semiconductor 106) via points D₁ and D₂.

FIG. 1c shows an electronic circuit diagram of an LED light source, according to an embodiment of the present invention. The circuit, designated generally as reference numeral 150, is configured for use at 110V/230V AC and comprises a plurality of resistors 126 in electrical connection with the LED semiconductor 106. The plurality of resistors 126 can be arranged into two sets, each set comprising two resistors arranged in parallel. Each set is connected in series with the LED semiconductor 106, here in the form of twin LEDs. It will be appreciated by a person skilled in the art that the twin LEDs are arranged so as to provide a constant light output when fed with an AC input. As mentioned above, the inner leads 110a may be electrically connected to the circuit 150 via points D₁ and D₂.

FIG. 1d shows an electronic circuit diagram of an LED light source, according to an alternative embodiment of the present invention. The circuit, designated generally as reference numeral 152, is configured for use at 110 V/230 V AC and comprises a plurality of resistors 126 and a bridge diode 128 in electrical connection with the LED semiconductor 106. The plurality of resistors 126 can be arranged into two sets, each set comprising two resistors arranged in parallel. Each set is connected in series with the LED semiconductor 106. The bridge diode 128 is connected to the resistors 126 and the LED semiconductor 106. It will be appreciated by a person skilled in the art that the diode bridge 128 provides full-wave rectification. As mentioned above, the inner leads 110a may be electrically connected to the circuit 152 via points D₁ and D₂.

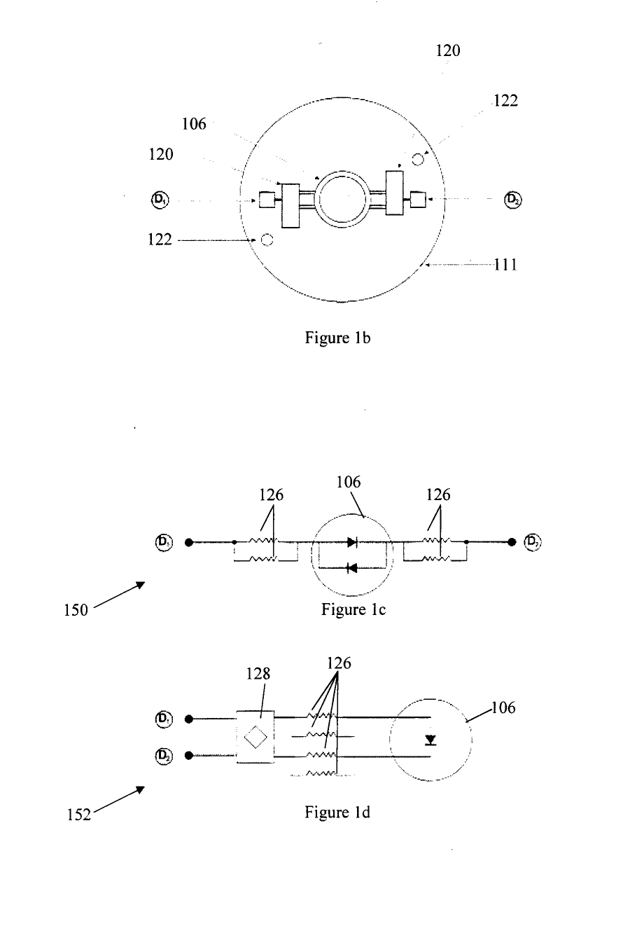

FIG. 2 is a schematic, generally designated as reference numeral 200, illustrating the formation of a convection current within an enclosure of an LED light source, according to an embodiment of the present invention. Convection currents 202, 204 and 206 are set-up with the enclosure and provide means for heat dissipation away from the LED semiconductor to the surface of the enclosure. The flow of the convection currents 202, 204 and 206 are laminar to facilitate efficient heat transfer. The shape of the enclosure is chosen such that it facilitates the funneling of the gas or gas mixture within the enclosure towards the junction of the LED. Heat from the surface of the enclosure is subsequently dissipated through radiation or convection with the ambient air. Accordingly, the material of the enclosure is preferably chosen to facilitate the transmission of light and the transfer of heat from the surface of the enclosure to the ambient surroundings by radiation. An example of such a suitable material is glass.

In an example embodiment of the present invention, the shape of the enclosure is in the form of a General Lighting Service (GLS) lamp, in particular, the conventional 60 mm diameter pear-shaped glass bulb. By using an existing bulb shape for the enclosure, existing 25 W, 40 W, 60 W and 100 W Tungsten Filament Lamps can be directly replaced with about 3 W, 6 W, 9 W and 16 W LED light sources according to embodiments of the present invention. No change in electrical wiring or design may be necessary as the same supply voltage sockets are used. The surface of the bulb can be made of clear glass, soft coated, diffused coated or coated with a reflective material for suitable/desirable lighting designs.

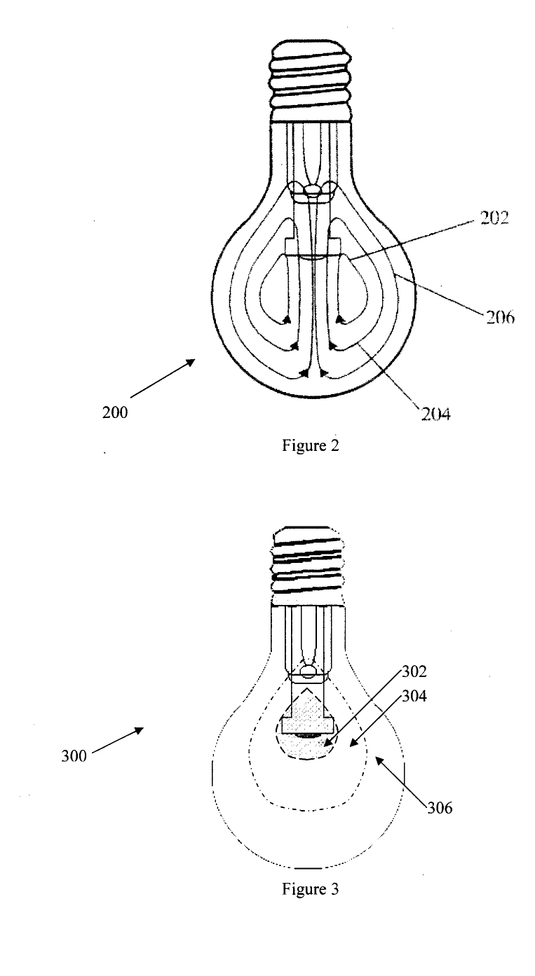

FIG. 3 is a schematic, generally designated as reference numeral 300, illustrating the temperature distribution within an LED light source, according to an embodiment of the present invention. The LED light source is rated at 230V AC, 0.020 A and 4.60 W and the temperature distribution during continuous operation (i.e.: at steady state) is shown. Around the areas denoted by reference numerals 302, 304 and 306, the temperature is about 60° C., 50° C. and 40° C. respectively.

Table 2 below shows operational data (e.g. colour temperature, downward lux, bulb surface temperature, weight) of various LED light sources in accordance with embodiments of the present invention.

| | | | | | Bulb | Bulb |
|---|---|---|---|---|---|---|
| Equivalent | | | CCT | Downward | Surface | weight |
| to GLS | Volts | Watts | (° K) | Lux | Temp. (° C.) | (gms) |
| 40 W | 230 | 5.8 | 6500 | 2,790 | 40 | 30 |
| 60 W | 230 | 5.0 | 5000 | 3,110 | 40 | 30 |
| 25 W | 230 | 3.5 | 6500 | 1,454 | 40 | 30 |

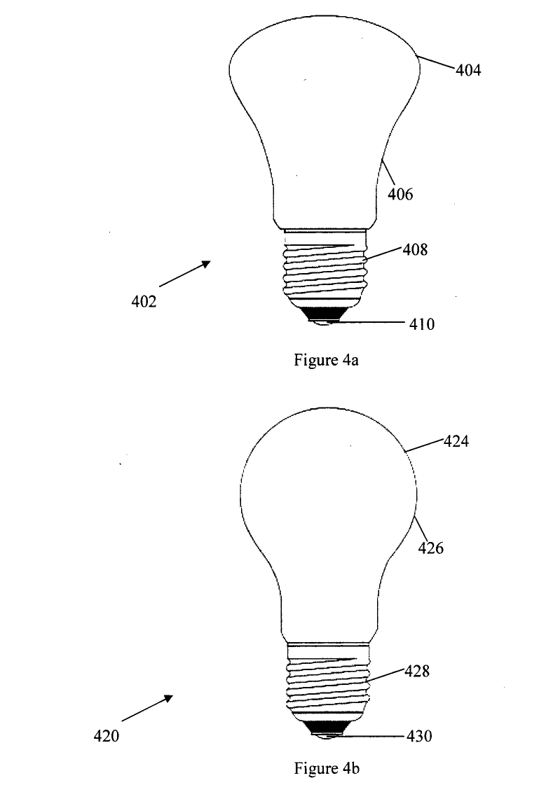

FIG. 4a is a schematic diagram of an LED light source, according to an embodiment of the present invention. The LED light source 402 comprises an enclosure 404 that is “mushroom” shaped (ellypso-paraboloid shaped). The enclosure 404 comprises a clear or frosted glass bulb, and can be partially coated with a diffusing reflector coating 406. The LED light source 402 further comprises a base having an E27/27 cap 408, the cap 408 having a lead-free solder or weld base tip 410. The LED light source 402 may be used for down-lighting.

FIG. 4b is a schematic diagram of an LED light source, according to another embodiment of the present invention. The LED light source 420 comprises an enclosure 424 that is “pear” shaped. The enclosure 424 comprises a clear or frosted glass bulb, and can be partially coated with a diffusing reflector coating 426. The LED light source 420 further comprises a base having an E27/27 cap 428, the cap 428 having a lead-free solder or weld base tip 430. The LED light source 420 may be used for down-lighting.

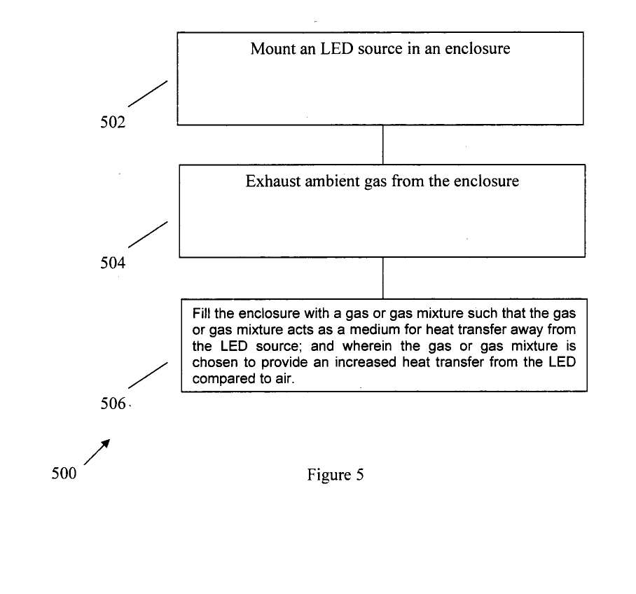

FIG. 5 is a flow chart, designated generally as reference numeral 500, illustrating a method of manufacturing a light emitting diode (LED) light source, according to an example embodiment of the present invention. At step 502, an LED source is mounted in an enclosure. At step 504, ambient gas is exhausted from the enclosure. At step 506, the enclosure is filled with a gas or gas mixture such that the gas or gas mixture acts as a medium for heat transfer away from the LED source; and wherein the gas or gas mixture is chosen to provide an increased heat transfer from the LED source compared to air.

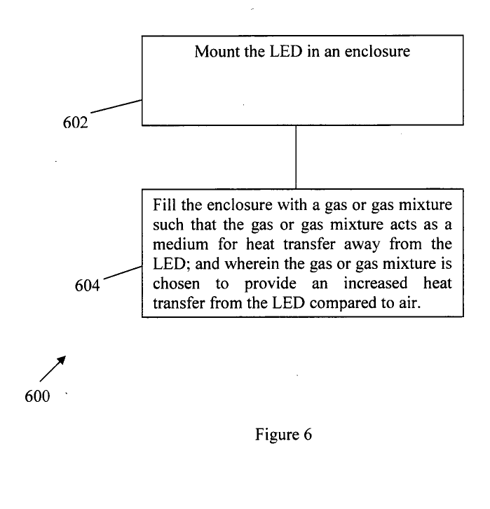

FIG. 6 is a flow chart, designated generally as reference numeral 600, illustrating a method of cooling a light emitting diode (LED), according to an example embodiment of the present invention. In this example embodiment, the LED is advantageously cooled without the aid of a metallic heatsink. At step 602, the LED is mounted in an enclosure. At step 604, the enclosure is filled with a gas or gas mixture such that the gas or gas mixture acts as a medium for heat transfer away from the LED; and wherein the gas or gas mixture is chosen to provide an increased heat transfer from the LED compared to air.

In embodiments of the present invention, a proper selection of the constituent gases for heat dissipation, its quantity (and therefore pressure, assuming a fixed enclosure shape) and the shape of the enclosure and the bulb surface finish advantageously enable the operation of LEDs around their safe junction temperature.

Embodiments of the present invention advantageously enable relatively faster heat dissipation compared to metallic heat sinks. An increase in power output without a substantial increase in operating temperature may be achieved. In other words, an increase in light output may be achieved with no additional input power. Increased light output for the same input power, i.e. an increase in Lumens per Watt (LPW), means that recurring cost is lower as less energy is required. Embodiments of the present invention can also prolong the life span of LED light sources. Embodiments of the present invention provide a “Green” light source solution.

It will be appreciated by a person skilled in the art that numerous variations and/or modifications may be made to the present invention as shown in the embodiments without departing from a spirit or scope of the invention as broadly described. The embodiments are, therefore, to be considered in all respects to be illustrative and not restrictive.

1. A light emitting diode (LED) light source, comprising:
an LED board comprising an LED source and control circuitry for the LED source;
a support configured to support the LED board; and
an enclosure surrounding the LED board;
wherein a gas or gas mixture is filled within the enclosure such that the gas or gas mixture acts as a medium for heat transfer away from the LED board; and wherein the gas or gas mixture is chosen to provide an increased heat transfer from the LED board compared to air.

2. The LED light source as claimed in claim 1, wherein the support comprises a spring support.

3. The LED light source as claimed in claim 1, wherein the heat is transferred from the LED source to the surface of the enclosure by convection current.

4. The LED light source as claimed in claim 1, wherein the material of the enclosure is chosen to facilitate the transmission of light and the transfer of heat from the surface of the enclosure to the ambient surroundings by radiation.

5. The LED light source as claimed in claim 1, wherein the surface of the enclosure comprises glass.

6. The LED light source as claimed in claim 1, wherein the gas or gas mixture has a combined molecular weight of less than 5.3.

7. The LED light source as claimed in claim 1, wherein the gas or gas mixture has a combined thermal conductivity of more than 0.14 W/g/° C.

8. The LED light source as claimed in claim 1, wherein the enclosure facilitates the funneling of the gas or gas mixture towards the LED board.

9. The LED light source as claimed in claim 1, wherein the LED source comprises a LED semiconductor structure.

10. The LED light source as claimed in claim 1, further comprising an electrical connection from the LED light source to the mains supply.

11. The LED light source as claimed in claim 1, further comprising a stem for mounting the LED board within the enclosure.

12. The LED light source as claimed in claim 1, wherein the gas comprises Hydrogen.

13. The LED light source as claimed in claim 1, wherein the gas mixture comprises Nitrogen and Helium.

14. The LED light source as claimed in claim 1, wherein the gas mixture comprises Helium.

15. A method of manufacturing a light emitting diode (LED) light source, comprising the steps of:
mounting an LED board, comprising an LED source and control circuitry for the LED source, on a support in an enclosure;
exhausting ambient gas from the enclosure; and
filling the enclosure with a gas or gas mixture such that the gas or gas mixture acts as a medium for heat transfer away from the LED board; and wherein the gas or gas mixture is chosen to provide an increased heat transfer from the LED board compared to air.

16. A method of cooling a light emitting diode (LED), comprising the steps of:
mounting an LED board, comprising the LED and control circuitry for the LED, on a support in an enclosure; and
filling the enclosure with a gas or gas mixture such that the gas or gas mixture acts as a medium for heat transfer away from the LED; and wherein the gas or gas mixture is chosen to provide an increased heat transfer from the LED compared to air.

17. The LED light source as claimed in claim 2, wherein the heat is transferred from the LED source to the surface of the enclosure by convection current.

18. The LED light source as claimed in claim 17, wherein the material of the enclosure is chosen to facilitate the transmission of light and the transfer of heat from the surface of the enclosure to the ambient surroundings by radiation.

19. The LED light source as claimed in claim 18, wherein the gas or gas mixture has a combined molecular weight of less than 5.3.

20. The LED light source as claimed in claim 19, wherein the gas or gas mixture has a combined thermal conductivity of more than 0.14 W/g/° C.
